(19) United States
(12) Patent Application Publication
(10) Pub. No.: US 2013/0327800 A1
(43) Pub. Date: Dec. 12, 2013

(54) VEHICLE INTERIOR ORGANIZER

(71) Applicant: Qing Wen Xu, Los Angeles, CA (US)

(72) Inventor: Qing Wen Xu, Los Angeles, CA (US)

(21) Appl. No.: 13/493,874

(22) Filed: Jun. 11, 2012

(51) Int. Cl. B60R 7/04

(52) U.S. Cl. 224/275

(57) ABSTRACT

A vehicle interior organizer device includes a body panel with a front side, a back side, a forward area, and a rear area. The body panel comprises a semi-rigid material, where the rear area of the body panel is configured to secure between a center console and a front seat. The vehicle interior organizer device includes at least one storage compartment configured to couple to the forward area of the front side of the body panel.

### BACKGROUND OF THE INVENTION

1. Field of the Invention

Embodiments of the invention described herein pertain to the field of organizers and more particularly, but not by way of limitation, one or more embodiments of the invention enable an organizer for use in vehicle interiors.

2. Description of the Related Art

Vehicle organizers are immensely popular to aid storage of personal belongings in the interior of vehicles. Most brand new vehicles have insufficient storage options for different individual drivers and passengers with varying storage and organizational needs.

There currently exist in the art a number of vehicle organizers, with most designed for a specific carrying purpose or for placement in a specific location of a vehicle. There are currently no systems that provide a versatile storage solution for the area between a front chair and a center console, even though it is one of the most easily accessible areas for a driver's or passenger's hands while seated.

As such, there is a need in the art for a vehicle interior organizer for placement between a front chair and a center console.

### BRIEF SUMMARY OF THE INVENTION

A vehicle interior organizer device includes a body panel with a front side, a back side, a forward area, and a rear area. The body panel comprises a semi-rigid material, where the rear area of the body panel is configured to secure between a center console and a front seat. The vehicle interior organizer device includes at least one storage compartment configured to couple to the forward area of the front side of the body panel.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a vehicle interior organizer in accordance with an embodiment of the present invention;

FIG. 2 illustrates a back view of a vehicle interior organizer in accordance with an embodiment of the present invention;

FIG. 3 illustrates a vehicle interior organizer in accordance with an embodiment of the present invention placed inside a vehicle.

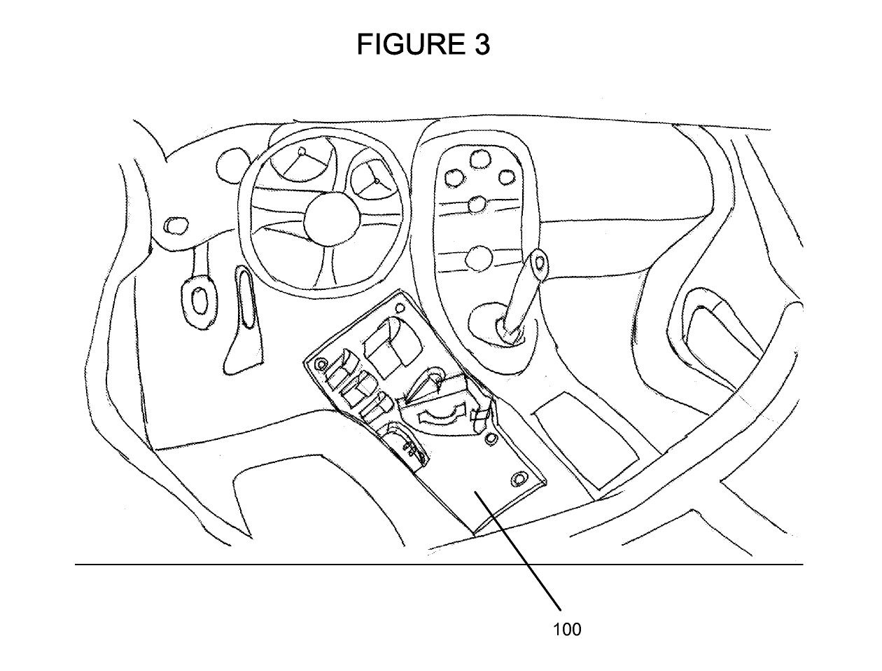

### DETAILED DESCRIPTION

A vehicle interior organizer device will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the true scope of the invention.

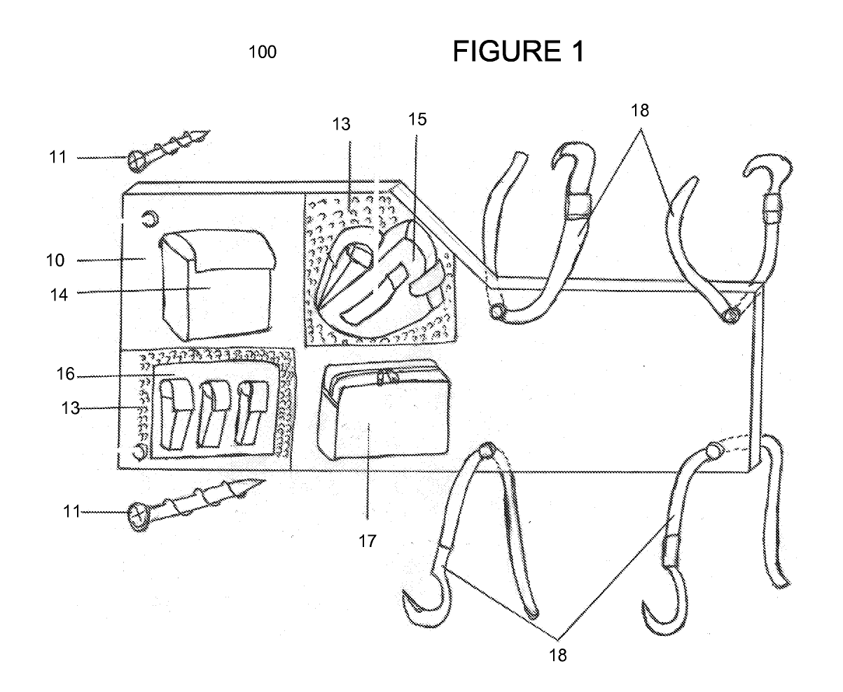

FIG. 1 illustrates a vehicle interior organizer in accordance with an embodiment of the present invention. A vehicle interior organizer device 100 in accordance with an embodiment of the present invention includes a body panel 10. The body panel 10 is rectangular planar shaped. In some embodiments, the body panel 10 has a substantially uniform thickness. The body panel 10 includes a front side, a back side, a forward area, and a rear area. The rear area of the body panel 10 is configured to secure between a center console and a front seat. In some embodiments, the body panel 10 comprises a semi-rigid material. In some embodiments, the thickness of the rear area of the body panel 10 is slightly than the width of a gap between a vehicle chair and a center console. This slightly wider thickness in of the body panel 10 material allows the body panel 10 to secure itself between the vehicle chair and center console.

In some embodiments, the body panel 10 is configured to secure between the center console and the front seat by at least one elastic cord 18. Each elastic cord 18 ends in a hook. A possible configuration is to secure four corners of the body panel 10 with four elastic cords 18. The hook on each of the elastic cords 18 may be then attached to various appropriate vehicle interior features. In some other embodiments, the body panel 10 is configured to secure between the center console and the front seat by screws 11 extending through the body panel 10 into the center console. This configuration ensures a most stable stance for the body panel 10 at the cost of causing alternations to the vehicle interior. In some embodiments, the body panel 10 is configured to secure between the center console and the front seat by Velcro hook fasteners 21 coupled to the back side of the body panel 10. It is common for the surface of the center console facing the front seat to include surface features similar to Velcro loop fasteners. The Velcro hook fasteners 21 in this case would couple to those surface features.

At least one storage compartment couples to the forward area of the front side of the body panel 10. A number of different storage compartments may be selected for varying needs of a vehicle user. Storage compartments may include zippered pouches 17, Velcro flapped pouches 16, pockets 14, pistol holsters 15, knife sheath, tool clips, or any other suitable open or closed storage enclosures. Because of the vicinity of the body panel 10 to a vehicle user's hips, where a weapon is normally carried on the vehicle user's body, a pistol holster 15 or knife sheath allows ergonomically natural and quick access to the weapon. This position for storage compartments may be particularly useful for law enforcement officers who may require quick and reliable access to their weapons.

In some embodiments the storage compartments are permanently coupled to the body panel 10 while in some embodiments the storage compartments are removably coupled to the body panel 10. Removability may be accomplished by using Velcro hook 13 and loop fasteners to removably couple the storage compartments with the body panel 10. By covering a large portion of the front side of the body panel 10 with Velcro hook 13 or loop fasteners, the storage compartments may be removably coupled in a variety of locations and orientations on the body panel 10.

In some embodiments, the storage compartments are configured to couple to the forward area of the front side of the body panel 10 with interlocking straps. Straps allow for a more secure coupling than Velcro hook and loop fasteners at the expense of having a slower speed of installation and removal.

In some embodiments, the forward area of the body panel 10 has a taller height than the rear area of the body panel 10. This uneven height makes room to allow a compartment to be coupled to the forward area of back side of the panel.

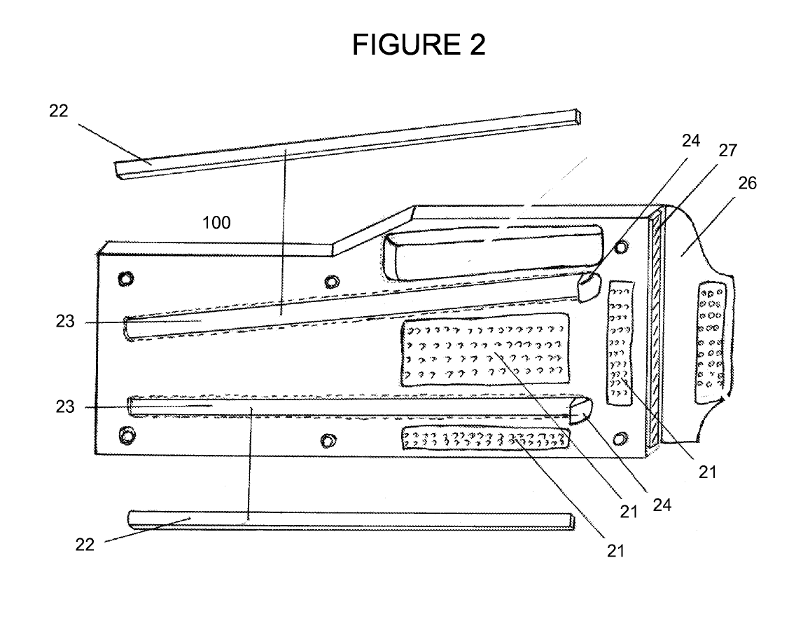

FIG. 2 illustrates a back view of a vehicle interior organizer in accordance with an embodiment of the present invention. In some embodiments, the body panel 10 includes an outer enclosure and an insert 27 within the outer enclosure. The insert 27 may be removable from the outer enclosure. The outer enclosure may include a closeable flap 26 to allow the insert 27 to be added or removed from the outer enclosure. The insert 27 may be interchangeable with inserts of varying thicknesses and materials. The outer enclosure 26 may include nylon, polyamides, plastic, polyethylene terephthalate, natural or synthetic cloth, or any other suitable material commonly used in the art for enclosures. The insert 27 may include wood, metal, fiberglass, plastic, rubber, ethylene vinyl acetate, cardboard, polystyrene foam or any other suitable material. An elastic or semi-rigid material for the insert 27, such as rubber, ethylene vinyl acetate, or polystyrene foam, improves securing the body panel 10 between the vehicle chair and console. The insert may be shaped as a flat panel or may be deformed to match a curvature of a space between the center console and the front chair.

In some embodiments, at least one deformable bar 22 couples to the back side of the body panel 10. Each of the deformable bars is 22 placed substantially parallel to a length of the body panel 10. The deformable 22 bars may include wood, metal, fiberglass, plastic, rubber, ethylene vinyl acetate, or any other suitable materials. The purpose of the deformable bar 22 is to provide the back panel with a structure when the back panel is made of an elastic or semi-rigid material.

The deformable bar may be shaped as a straight bar or may be deformed to match a curvature of a space between the center console and the front chair. The deformable bar's shape may be predetermined prior to production to match certain makes and models of vehicles or deformed by a vehicle user to match the vehicle user's particular vehicle.

In some embodiments, at least one bar enclosure 23 couples to the back side of the body panel 10, where each of bar enclosure 23 is configured to enclose a deformable bar 22. Each of the bar enclosures 23 includes a closeable flap 24 which allows insertion or removal of the deformable bar 22 from the bar enclosure 23.

What is claimed is:

1. A vehicle interior organizer device comprising:
a body panel with a front side, a back side, a forward area, and a rear area,
wherein said body panel comprises a semi-rigid material, and
wherein said rear area of said body panel is configured to secure between a center console and a front seat; and
at least one storage compartment configured to couple to said forward area of said front side of said body panel.

2. The device of claim 1, wherein said body panel comprises an outer enclosure and an insert enclosed within said outer enclosure.

3. The device of claim 2, wherein said insert is removable from said outer enclosure and interchangeable with inserts of varying thicknesses and materials.

4. The device of claim 2, wherein said outer enclosure comprises nylon, polyamides, plastic, polyethylene terephthalate, and/or natural or synthetic cloth material.

5. The device of claim 2, wherein said insert comprises wood, metal, fiberglass, plastic, rubber, ethylene vinyl acetate, cardboard, and/or polystyrene foam.

6. The device of claim 2, wherein said outer enclosure comprises a closeable flap.

7. The device of claim 1, wherein one or more of said at least one storage compartment is removably coupled to said forward area of said front side of said body panel.

8. The device of claim 7, wherein said one or more of said at least one storage compartment is configured to secure to said forward area of said front side of said body panel with Velcro hook and loop fasteners.

9. The device of claim 7, wherein said one or more of said at least one storage compartment is configured to be able to mount to mount to a variety of different locations on said body panels and in a variety of different orientations.

10. The device of claim 7, wherein said one or more of said at least one storage compartment is configured to couple to said forward area of said front side of said body panel with interlocking straps.

11. The device of claim 1, wherein said body panel is configured to secure between said center console and said front seat by at least one elastic cord with a hook coupled to each of said elastic cords.

12. The device of claim 1, wherein said body panel is configured to secure between said center console and said front seat by screws extending through said body panel into said center console.

13. The device of claim 1, wherein said body panel is configured to secure between said center console and said front seat by Velcro hook fasteners coupled to said back side of said body panel.

14. The device of claim 1, further comprising at least one deformable bar coupled to said back side of said body panel, wherein each of said at least one deformable bar is substantially parallel to a length of said body panel.

15. The device of claim 14, wherein said at least one deformable bar comprises wood, metal, fiberglass, plastic, rubber, ethylene vinyl acetate.

16. The device of claim 1, further comprising at least one bar enclosure coupled to said back side of said body panel, wherein each of said at least one bar enclosure is configured to enclose a deformable bar.

17. The device of claim 16, wherein each of said at least one bar enclosure comprises a closeable flap.

18. The device of claim 1, further comprising at least one storage compartment configured to couple to forward area of said back side of said body panel.
